(19) United States
(12) Patent Application Publication
(10) Pub. No.: US 2023/0245056 A1
(43) Pub. Date: Aug. 3, 2023

(54) DEMAND ESTIMATION APPARATUS, DEMAND ESTIMATION METHOD, AND COMPUTER-READABLE RECORDING MEDIUM

(71) Applicant: NEC Corporation, Minato-ku, Tokyo (JP)

(72) Inventors: Mamoru IGUCHI, Tokyo (JP); Saki NAGAKI, Tokyo (JP)

(73) Assignee: NEC Corporation, Minato-ku, Tokyo (JP)

(21) Appl. No.: 18/009,822

(22) PCT Filed: Jun. 18, 2020
(86) PCT No.: PCT/JP2020/023898

§ 371 Date: Dec. 12, 2022

(51) Int. Cl. G06Q 10/087; G06Q 10/083; G06Q 30/0202

(52) U.S. Cl. CPC G06Q 10/087; G06Q 10/0838; G06Q 30/0202

(57) ABSTRACT

The demand estimation apparatus includes a demand estimation unit that estimate demand for a new component by inputting meta-information of the new component and information regarding use of the new component to a first machine learning model. The first machine learning model is constructed by machine learning using the second machine learning model, meta information of an existent component that is training data for the second machine learning model, and meta information of new component. The second machine learning model predicts demand for existent component using the meta information of the existent component and information regarding use of existent component as input.

### TECHNICAL FIELD

The present invention relates to a demand estimation apparatus and a demand estimation method for estimating demand for a component, and furthermore relates to a computer-readable recording medium on which a program for realizing these is recorded.

### BACKGROUND ART

When running mechanical equipment, a vehicle, or the like, having a large inventory of maintenance components leads to an increase in the running cost. Therefore, in recent years, systems for estimating demand for maintenance components in order to optimize an inventory of maintenance components have been proposed.

Patent Document 1 discloses a system for calculating a demand estimation value for a future shipment quantity of maintenance components to be used for maintenance of a product, using a demand estimation model, for example. In the system disclosed in Patent Document 1, the demand estimation model is constructed based on shipment records and demand records of maintenance components.

### LIST OF RELATED ART DOCUMENTS

### Patent Document

Patent Document 1: Japanese Patent Laid-Open Publication No. 2013-182498

### SUMMARY OF INVENTION

### Problems To Be Solved By The Invention

However, when a product is remodeled, or a new product is released, a new maintenance component may be used, but the new maintenance component has no or few shipment records and demand records. Therefore, the system disclosed in Patent Document 1 above has a problem in that it is difficult to estimate demand for a new maintenance component.

An example object of the present invention is to provide a demand estimation apparatus, a demand estimation method, and a computer-readable recording medium that can solve the above problem, and estimate demand for even a component with few records of past shipment.

### Means For Solving The Problems

In order to achieve the above-described object, a first demand estimation apparatus includes:

a demand estimation unit that estimate demand for a new component by inputting meta-information of the new component and information regarding use of the new component to a machine learning model for receiving, as input, meta-information of an existent component and information regarding use of the existent component and estimating demand for the existent component.

In order to achieve the above-described object, a second demand estimation apparatus includes:

an estimation value obtaining unit that obtains an estimation value for a new component by inputting meta-information of the new component to a machine learning model for estimating demand for an existent component, the machine learning model receiving meta-information of an existent component as input and outputting an estimation value for demand for the existent component;

a model training unit that constructs a machine learning model for estimating demand for the new component by performing machine learning on a relation between the meta-information of the existent component, the obtained estimation value for the new component, and the meta-information of the new component; and

a demand estimation unit that estimates demand for the new component by inputting the meta-information of the new component to the machine learning model for estimating demand for the new component.

In addition, in order to achieve the above-described object, a first demand estimation method includes:

a demand estimation step of estimating demand for a new component by inputting meta-information of the new component and information regarding use of the new component to a machine learning model for receiving, as input, meta-information of an existent component and information regarding use of the existent component and estimating demand for the existent component.

In addition, in order to achieve the above-described object, a second demand estimation method includes:

an estimation value obtaining step of obtaining an estimation value for a new component by inputting meta-information of the new component to a machine learning model for estimating demand for an existent component, the machine learning model receiving meta-information of an existent component as input and outputting an estimation value for demand for the existent component;

a model training step of constructing a machine learning model for estimating demand for the new component by performing machine learning on a relation between the meta-information of the existent component, the obtained estimation value for the new component, and the meta-information of the new component; and

a demand estimation step of estimating demand for the new component by inputting the meta-information of the new component to the machine learning model for estimating demand for the new component.

Furthermore, in order to achieve the above-described object, a first computer readable recording medium according to an example aspect of the invention is a computer readable recording medium that includes recorded thereon a program,

the program including instructions that cause the computer to carry out:

a demand estimation step of estimating demand for a new component by inputting meta-information of the new component and information regarding use of the new component to a machine learning model for receiving, as input, meta-information of an existent component and information regarding use of the existent component and estimating demand for the existent component.

Furthermore, in order to achieve the above-described object, a second computer readable recording medium according to an example aspect of the invention is a computer readable recording medium that includes recorded thereon a program,

the program including instructions that cause the computer to carry out:

an estimation value obtaining step of obtaining an estimation value for a new component by inputting meta-information of the new component to a machine learning model for estimating demand for an existent component,_the machine learning model receiving meta-information of an existent component as input and outputting an estimation value for demand for the existent component;

a model training step of constructing a machine learning model for estimating demand for the new component by performing machine learning on a relation between the meta-information of the existent component, the obtained estimation value for the new component, and the meta-information of the new component; and

a demand estimation step of estimating demand for the new component by inputting the meta-information of the new component to the machine learning model for estimating demand for the new component.

### ADVANTAGEOUS EFFECTS OF THE INVENTION

As described above, according to the invention, it is possible to estimate demand for even a component with few records of past shipment.

### BRIEF DESCRIPTION OF THE DRAWINGS

FIG. 1 is a configuration diagram showing the schematic configuration of the demand estimation apparatus according to the first example embodiment.

FIG. 2 is a block diagram specifically showing the configuration of the demand estimation apparatus according to the first example embodiment.

FIG. 3 is a diagram conceptually showing learning processing and estimation processing that are performed by the machine learning model according to the first example embodiment.

FIG. 4 is a flowchart showing operations of the demand estimation apparatus according to the first example embodiment.

FIG. 5 is a configuration diagram showing the schematic configuration of the demand estimation apparatus according to the second example embodiment.

FIG. 6 is a block diagram showing the configuration of the demand estimation apparatus according to the second example embodiment in detail.

FIG. 7 is a diagram conceptually showing learning processing and estimation processing that are performed by the machine learning model according to the second example embodiment.

FIG. 8 is a flowchart showing operations of the demand estimation apparatus according to the second example embodiment during training processing.

FIG. 9 show information to be used for the specific example 1.

FIG. 10 show information to be used for the specific example 2.

FIG. 11 show information to be used for the specific example 3.

FIG. 12 is a block diagram illustrating an example of a computer that realizes the demand estimation apparatus according to the first and second example embodiment.

### EXAMPLE EMBODIMENT

### First Example Embodiment

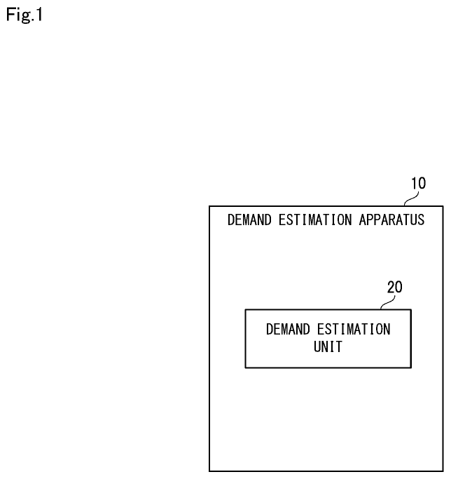

A demand estimation apparatus, a demand estimation method, and a program according to a first example embodiment will be described with reference to FIGS. 1 to 4.

### Apparatus Configuration

First, a schematic configuration of the demand estimation apparatus according to the first example embodiment will be described with reference to FIG. 1. FIG. 1 is a configuration diagram showing the schematic configuration of the demand estimation apparatus according to the first example embodiment.

A demand estimation apparatus 10 according to the first example embodiment shown in FIG. 1 is an apparatus for estimating demand for a component of a mechanical apparatus, a vehicle, or the like. As shown in FIG. 1, the demand estimation apparatus 10 includes a demand estimation unit 20.

The demand estimation unit 20 estimates demand for a new component by inputting meta-information of the new component and information regarding use of the new component, to a machine learning model for estimating demand for an existent component by receiving, as input, meta-information of the existent component and information regarding use of the existent component. The existent component is a component with records of past shipment, in many cases.

In this manner, in the first example embodiment, information regarding a new component is input to a machine learning model for estimating demand for an existent component, and demand for the new component is estimated. According to the example embodiment, it is possible to estimate demand for even a new component with no or few records of past shipment.

Examples of a new component include a component that is used for a new product in mechanical equipment, a vehicle, or the like. In this case, the new component is similar to an existent component in most cases, but is designed based on the specifications of the new product, and is different from the existent component used for an old model of the product, in terms of the replacement cycle, the number of components that are used, and the like, in many cases. Therefore, it is difficult to estimate demand for a new component based on a demand estimation result of an existent component.

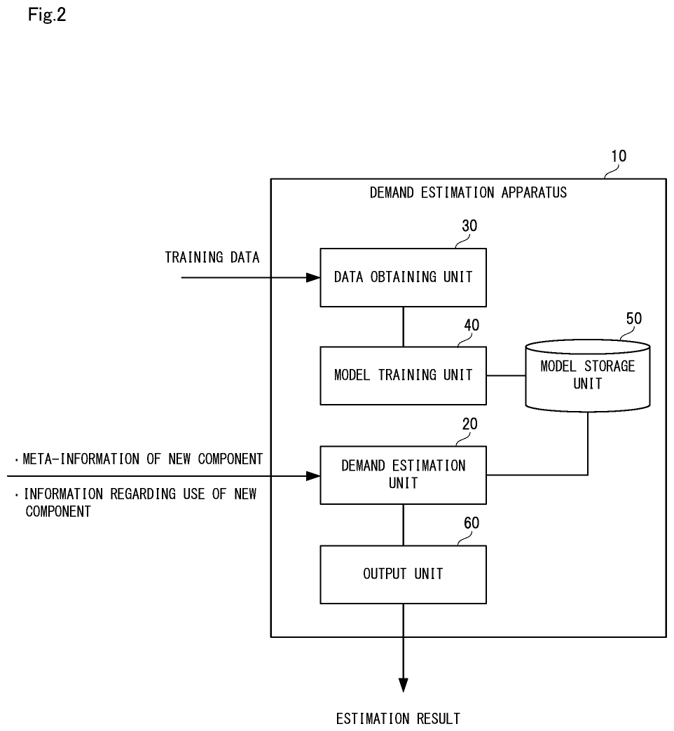

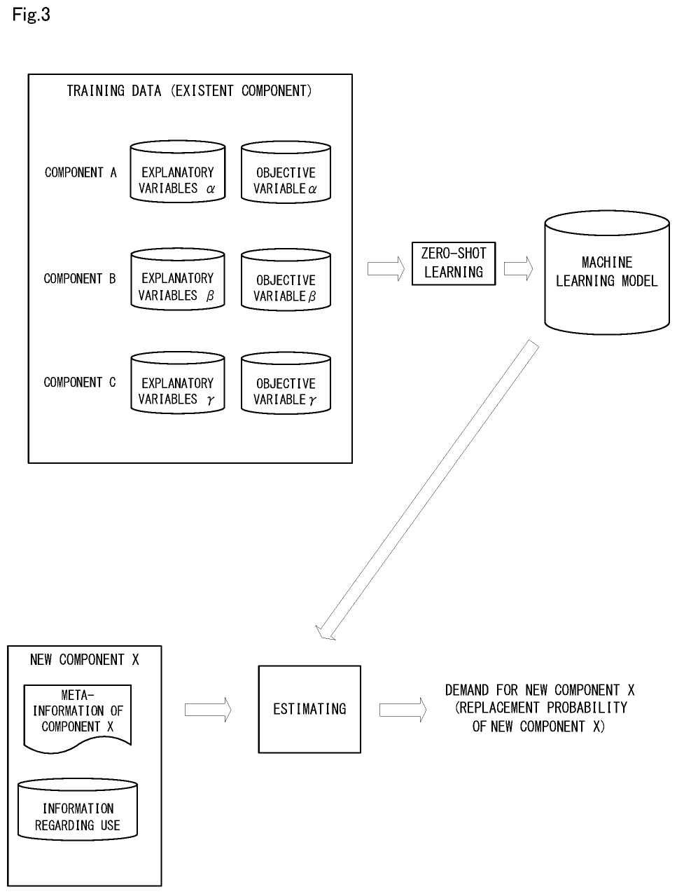

Next, configurations and functions of the demand estimation apparatus according to the example embodiment will be described in detail with reference to FIGS. 2 and 3. FIG. 2 is a block diagram specifically showing the configuration of the demand estimation apparatus according to the first example embodiment.

As shown in FIG. 2, in the first example embodiment, the demand estimation apparatus 10 includes a data obtaining unit 30, a model training unit 40, a model storage unit 50, and an output unit 60, in addition to the above demand estimation unit 20.

The data obtaining unit 30 obtains training data for a machine learning model. In the first example embodiment, the training data for the machine learning model includes meta-information of an existent component represented by explanatory variables, information regarding use of the existent component also represented by explanatory variables, and information indicating demand for the existent component represented by objective variables.

Specifically, the data obtaining unit 30 obtains meta-information of an existent component, information regarding use of the existent component, and information indicating demand for the existent component, from an external apparatus such as a terminal apparatus connected to the demand estimation apparatus 10 via a network.

Here, meta-information of a component is information that can be related to demand for the component, for example, and is information indicating the characteristics of the component. Specific examples of meta-information of a component include the name (component name), type, mounting site, material, function, application, model number, and the like of the component, the name of an apparatus in which the component is to be mounted (apparatus name), and the like. Note that meta-information of a component is not limited to the above information.

Information regarding use of a component (explanatory variable) is information obtained when the component was used, for example. Specific examples of information regarding use of a component include information indicating use records, information indicating an operation status, information indicating a use environment, and the like. Note that information regarding use of a component is not limited to the above information.

Information indicating demand for a component (objective variable) is information related to a need for the component (need for component replacement), for example. Specific examples of information indicating demand for a component include information indicating an inspection day, whether or not replacement is to be performed, a replacement timing, the number of replacement components, replacement probability, and the like. Note that information indicating demand for a component is not limited to the above information.

The model training unit 40 executes machine learning using the training data obtained by the data obtaining unit 30, and constructs a machine learning model. Techniques of machine learning in this case include zero-shot learning, deep learning, ridge regression, logistic regression, support vector machine, gradient boosting, and the like. In addition, the model training unit 40 stores the constructed machine learning model in the model storage unit 50.

Construction and demand estimation of the machine learning model will be described with reference to FIG. 3. FIG. 3 is a diagram conceptually showing learning processing and estimation processing that are performed by the machine learning model according to the first example embodiment. In the example in FIG. 3, the machine learning model is constructed through zero-shot learning that uses explanatory variable sets (each of which includes meta-information and information regarding use) and objective variables prepared respectively for existent components A to C as training data (see Reference Document 1 below). As shown in FIG. 3, the model training unit 40 constructs a machine learning model for performing demand estimation based on the explanatory variable sets of the existent components.

Note that the machine learning model is constructed through zero-shot learning, and a weight is set for each piece of meta-information during learning. Therefore, when an explanatory variable set of a new component (including meta-information and information regarding use) is input to the constructed machine learning model, it is possible to output an estimation value for demand for the new component.

Reference Document 1: written by Tomoya Sakai and Yasuhiro Sogawa, “An Approach to Unseen Class Classification with In-Service Predictors”, The 33^{rd} Annual Conference of the Japanese Society for Artificial Intelligence, 2019, <https://www.jstage.st.go.jp/article/pjsai/JSAI2019/0/JSAI2019_3Rin206/_article/-char/ja/>

As shown in FIG. 3, the demand estimation unit 20 first obtains meta-information of a new component that is a demand estimation target and information regarding use of the new component, from an external apparatus such as a terminal apparatus of the user connected to the demand estimation apparatus 10 via a network.

Next, the demand estimation unit 20 obtains the machine learning model from the model storage unit 50, and inputs meta-information of a new component that is a demand estimation target and information regarding use of the new component, to the obtained machine learning model. Accordingly, whether or not replacement is to be performed on a certain inspection day, the number of replacement components, and the like regarding the new component are output from the machine learning model as objective variables, that is to say, demand estimation results.

The output unit 60 transmits the results of estimation performed by the demand estimation unit 20, specifically the output objective variables, to an external apparatus such as a terminal apparatus of the user. Accordingly, the user can be aware of the estimated demand for the new component.

### Apparatus Operations

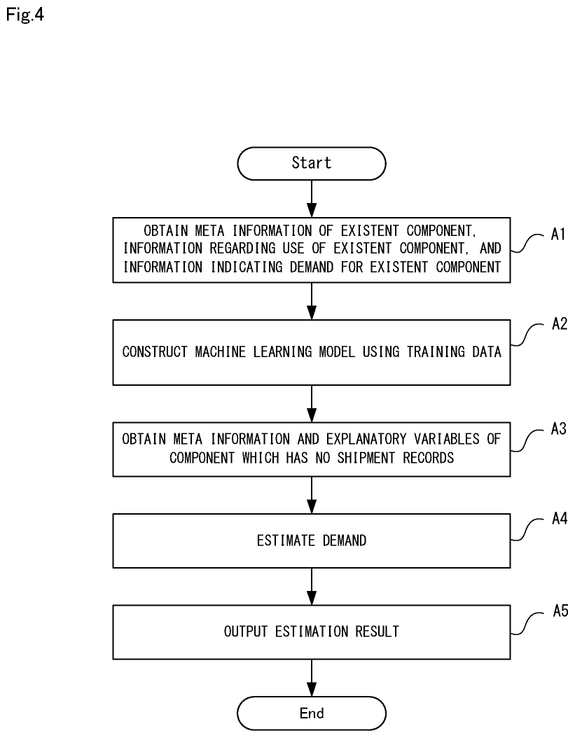

Next, operations of the demand estimation apparatus 10 according to the first example embodiment will be described with reference to FIG. 4. FIG. 4 is a flowchart showing operations of the demand estimation apparatus according to the first example embodiment. In the following description, FIGS. 1 to 3 will be referred to as appropriate. In addition, in the first example embodiment, a demand estimation method is carried out by causing the demand estimation apparatus 10 to operate. Thus, a description of the demand estimation method according to the first example embodiment is replaced by the following description of operations of the demand estimation apparatus.

As shown in FIG. 4, the data obtaining unit 30 first obtains, from an external apparatus, meta-information of an existent component, information regarding use of the existent component, and information indicating demand for the existent component (step A1).

Next, the model training unit 40 executes machine learning using the meta-information of the existent component, the information regarding use of the existent component (explanatory variables), and the information indicating demand for the existent component (objective variable) obtained in step A1, and constructs a machine learning model (step A2).

Next, the demand estimation unit 20 obtains, from the external apparatus, meta-information of a new component that is a demand estimation target and information regarding use of the new component (step A3).

Next, the demand estimation unit 20 inputs, to the machine learning model constructed in step A2, the meta-information of the new component that is a demand estimation target and the information regarding use of the new component, which have been obtained in step A3, and performs demand estimation (step A4).

The demand estimation unit 20 then transmits an estimation result to the external apparatus (step A5). If the external apparatus is a terminal apparatus of the user that has desired demand estimation, the estimation result is displayed on the screen of the terminal apparatus. Accordingly, the user can be aware of the estimation result of the new component for which demand estimation has been requested.

### Effects of First Example Embodiment

As described above, according to the first example embodiment, it is possible to estimate demand for a new component simply by inputting meta-information of the new component and information regarding use of the new component to a machine learning model for estimating demand for an existent component.

### Program

It suffices for a program in the first example embodiment to be a program that causes a computer to carry out steps A1 to A5 illustrated in FIG. 4. Also, by this program being installed and executed in the computer, the demand estimation apparatus and the demand estimation method according to the first example embodiment can be realized. In this case, a processor of the computer functions and performs processing as the demand estimation unit 20, the data obtaining unit 30, the model training unit 40, and the output unit 60.

In the example embodiment, the model storage unit 50 may be realized by storing the data files constituting this in a storage device such as a hard disk provided in the computer. Also, the model storage unit 50 may be realized by a storage device of another computer. The computer includes general-purpose PC, smartphone and tablet-type terminal device.

A program according to the first example embodiment may also be executed by a computer system constructed by a plurality of computers. In this case, for example, each of the computers may function as one of the demand estimation unit 20, the data obtaining unit 30, the model training unit 40, and the output unit 60.

### Second Example Embodiment

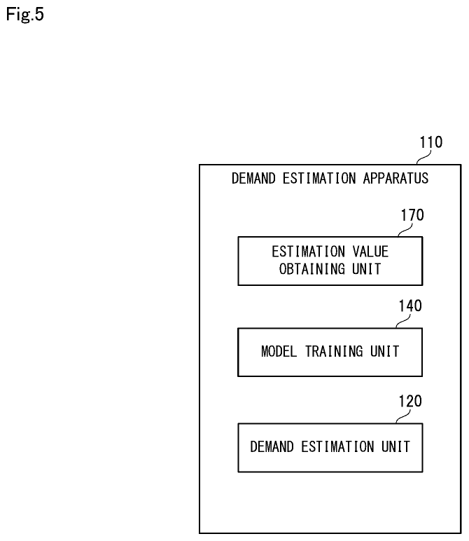

Next, a demand estimation apparatus, a demand estimation method, and a program according to a second example embodiment will be described with reference to FIGS. 5 to 8.

### Apparatus Configuration

First, a schematic configuration of the demand estimation apparatus according to the second example embodiment will be described with reference to FIG. 5. FIG. 5 is a configuration diagram showing the schematic configuration of the demand estimation apparatus according to the second example embodiment.

A demand estimation apparatus 110 according to the second example embodiment shown in FIG. 5 is also an apparatus for estimating demand for a component of a mechanical apparatus, a vehicle, or the like, similarly to the demand estimation apparatus 10 according to the first example embodiment. Note that the demand estimation apparatus 110 according to the second example embodiment is different from the demand estimation apparatus 10 according to the first example embodiment in demand estimation processing. Differences from the first example embodiment will be mainly described below.

As shown in FIG. 5, the demand estimation apparatus 110 according to the second example embodiment includes an estimation value obtaining unit 170, a model training unit 140, and a demand estimation unit 120.

The estimation value obtaining unit 170 inputs meta-information of a new component to a machine learning model for estimating demand for an existent component, and obtains an estimation value for the new component. Here, the machine learning model for estimating demand for an existent component (hereinafter, referred to as “existent-component demand estimation model”) is a model that receives meta-information of an existent component as input, and outputs an estimation value for demand for the existent component.

Unlike the first example embodiment, the model training unit 140 in the second example embodiment performs machine learning on the relation between meta-information of an existent component, an estimation value for a new component obtained by the estimation value obtaining unit 170, and meta-information of the new component, and constructs a machine learning model for estimating demand for the new component (hereinafter, referred to as “new-component demand estimation model”).

The demand estimation unit 120 inputs the meta-information of the new component to the new-component demand estimation model, and estimates demand for the new component.

In this manner, in the second example embodiment, the machine learning model for estimating demand for an existent component with records of past shipment is used for performing machine learning on the relation between the existent component and a new component. Therefore, also according to the second example embodiment, it is possible to estimate demand for even a new component with no records of past shipment.

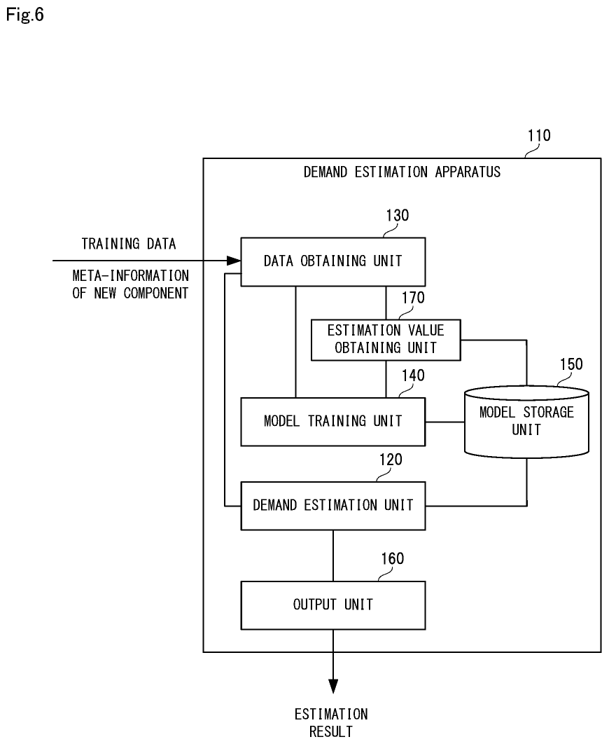

Next, the configuration and functions of the demand estimation apparatus according to the second example embodiment will be described in detail with reference to FIG. 6. FIG. 6 is a block diagram showing the configuration of the demand estimation apparatus according to the second example embodiment in detail.

As shown in FIG. 6, the demand estimation apparatus 110 according to the second example embodiment includes a data obtaining unit 130, a model storage unit 150, and an output unit 160, in addition to the estimation value obtaining unit 170, the model training unit 140, and the demand estimation unit 120, which have been described above.

The data obtaining unit 130 first obtains training data for the existent-component demand estimation model, from an external apparatus such as a terminal apparatus connected to the demand estimation apparatus 110 via a network, similarly to the data obtaining unit 30 according to the first example embodiment. In addition, the data obtaining unit 130 inputs the obtained training data to the model training unit 140.

The training data for the existent-component demand estimation model includes meta-information of an existent component represented by an explanatory variable and a record value of demand for the existent component represented by an objective variable. The meta-information in the second example embodiment is the same as that described in the first example embodiment. The record value of demand may be an actual replacement timing, the number of replacement components, or the like regarding the existent component.

In addition, the data obtaining unit 130 further obtains meta-information of a new component from the external apparatus. The data obtaining unit 130 inputs the obtained meta-information of the new component to the estimation value obtaining unit 170, the model training unit 140, and the demand estimation unit 120.

The model training unit 140 first executes machine learning using the training data obtained by the data obtaining unit 130, and constructs an existent-component demand estimation model. Machine learning techniques in this case include deep learning, ridge regression, logistic regression, support vector machine, gradient boosting, and the like. In addition, the model training unit 140 stores the constructed existent-component demand estimation model in the model storage unit 150.

Next, the model training unit 140 constructs a new-component demand estimation model. Specifically, in the second example embodiment, a new-component demand estimation model is constructed by executing weighting on the meta-information of the existent component and the meta-information of the new component using an estimation value for the new component obtained by the estimation value obtaining unit 170, the meta-information of the existent component, and the meta-information of the new component.

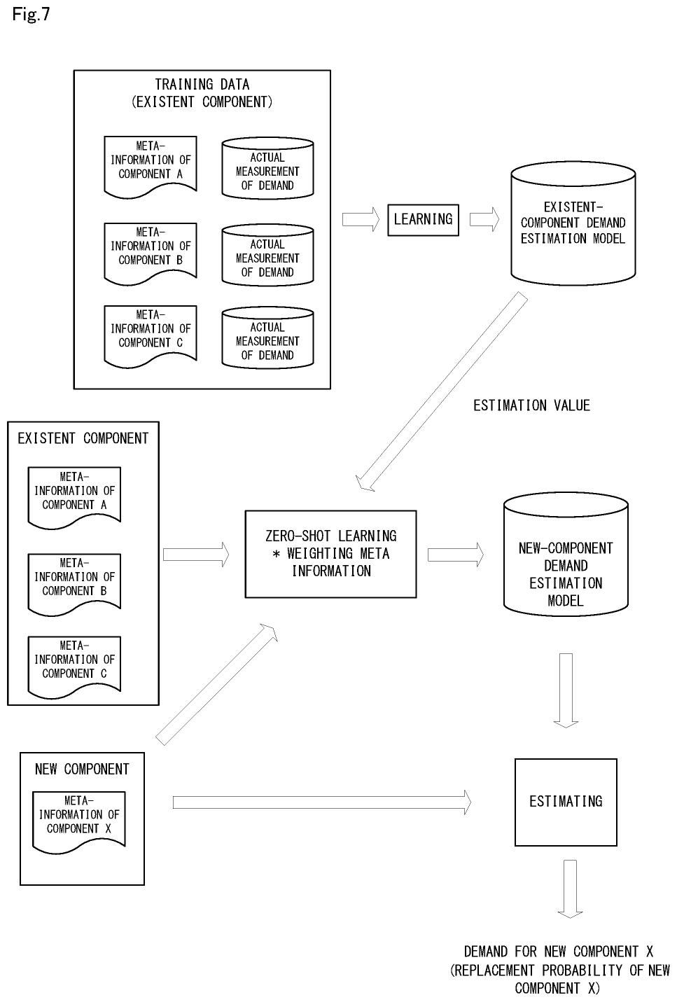

Here, construction of a new-component demand estimation model will be described with reference to FIG. 7. FIG. 7 is a diagram conceptually showing learning processing and estimation processing that are performed by the machine learning model according to the second example embodiment. In the example in FIG. 7, an existent-component demand estimation model is constructed through machine learning that uses meta-information and record values of demand prepared for the existent components A to C, as training data.

As shown in FIG. 7, in the second example embodiment, the model training unit 140 performs zero-shot learning, and constructs a new-component demand estimation model. The zero-shot learning method is a learning method that is performed for classifying an unknown class using a known machine learning model.

Specifically, the model training unit 140 constructs a new-component demand estimation model by executing weighting on meta-information of an existent component and meta-information of a new component using an estimation value output when the meta-information of the new component is input to the existent component prediction model, the meta-information of the existent component, and the meta-information of the new component (see Reference Document 2 below).

Reference Document 2: written by Wiradee Imrattanatrai, Makoto Kato, and Masatoshi Yoshikawa, “Identifying Entity Properties from Text with Zero-shot Learning”, DEIM Forum 2019, <URL: https://db-event.jpn.org/deim2019/post/papers/343.pdf>

In addition, the demand estimation unit 120 inputs the meta-information of the new component obtained by the data obtaining unit 130 to the new-component demand estimation model, as shown in FIG. 7. Accordingly, as results of demand estimation, for example, inspection day, whether or not replacement is to be performed, replacement timing, the number of replacement components, and the like regarding the new component are output from the new-component demand estimation model.

The output unit 160 transmits a result of estimation performed by the demand estimation unit 120, specifically output objective variables, to an external apparatus such as a terminal apparatus of the user. Accordingly, the user can be aware of an estimated demand for the new component.

### Apparatus Operations

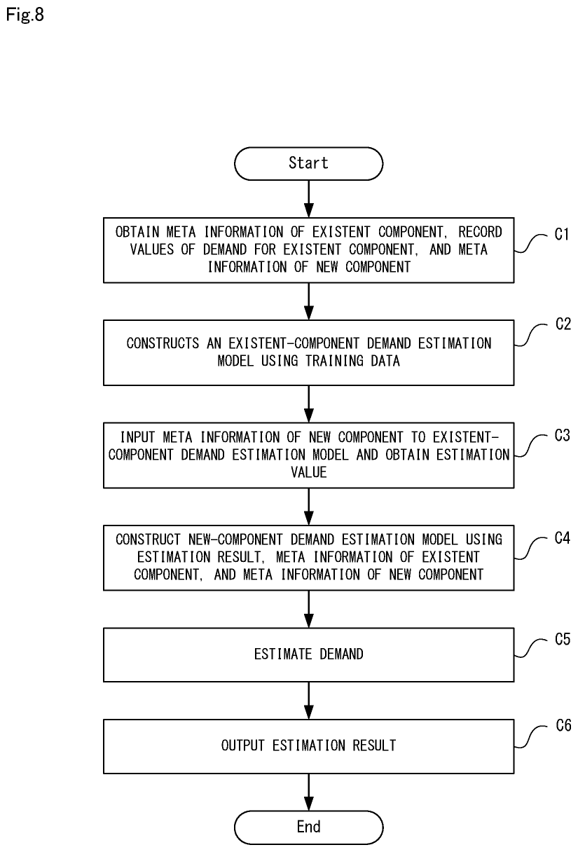

Next, operations of the demand estimation apparatus 110 according to the second example embodiment will be described with reference to FIG. 8. FIG. 8 is a flowchart showing operations of the demand estimation apparatus according to the second example embodiment during training processing. In the following description, FIGS. 6 and 7 will be referred to as appropriate. In addition, in the second example embodiment, a demand estimation method is carried out by causing the demand estimation apparatus 110 to operate. Thus, a description of the demand estimation method according to the second example embodiment is replaced by the following description of operations of the demand estimation apparatus.

As shown in FIG. 8, the data obtaining unit 30 first obtains meta-information of an existent component, record values of demand for the existent component, and meta-information of a new component, from an external apparatus (step C1).

Next, the model training unit 40 executes machine learning using the meta-information of the existent component (explanatory variable), and the record values of demand for the existent component (objective variable) obtained in step C1, and constructs an existent-component demand estimation model (step C2).

Next, the estimation value obtaining unit 170 inputs the meta-information of the new component obtained in step C1 to the existent-component demand estimation model constructed in step C2, and obtains an output estimation value (step C3).

Next, the model training unit 140 executes zero-shot learning using the estimation result obtained in step C3, the meta-information of the existent component obtained in step C1, and the meta-information of the new component also obtained in step C1. Accordingly, the model training unit 140 constructs a new-component demand estimation model that has learning the relation between the meta-information of the existent component and the meta-information of the new component (step C4).

Next, the demand estimation unit 120 inputs the meta-information of the new component obtained in step C1 to the new-component demand estimation model constructed in step C4, and performs demand estimation (step C5).

The output unit 160 then transmits the estimation result to the external apparatus (step C6). If the external apparatus is a terminal apparatus of the user that has desired demand estimation, the estimation result is displayed on the screen of the terminal apparatus. Accordingly, the user can be aware of the estimation result of the new component for which demand estimation has been requested.

### Effects of Second Example Embodiment

In the second example embodiment, as described above, the relation between meta-information of an existent component and meta-information of a new component is subjected to zero-shot learning using a machine learning model for estimating demand for the existent component. Therefore, according to the second example embodiment, it is possible to estimate demand for even a new component.

### Program

It suffices for a program in the second example embodiment to be a program that causes a computer to carry out steps C1 to C6 illustrated in FIG. 8. Also, by this program being installed and executed in the computer, the demand estimation apparatus and the demand estimation method according to the second example embodiment can be realized. In this case, a processor of the computer functions and performs processing as the demand estimation unit 120, the data obtaining unit 130, the model training unit 140, the output unit 160 and estimation value obtaining unit 170.

In the second example embodiment, the model storage unit 150 may be realized by storing the data files constituting this in a storage device such as a hard disk provided in the computer. Also, the model storage unit 150 may be realized by a storage device of another computer. The computer includes general-purpose PC, smartphone and tablet-type terminal device.

A program according to the second example embodiment may also be executed by a computer system constructed by a plurality of computers. In this case, for example, each of the computers may function as one of the demand estimation unit 120, the data obtaining unit 130, the model training unit 140, the output unit 160 and estimation value obtaining unit 170.

### SPECIFIC EXAMPLES

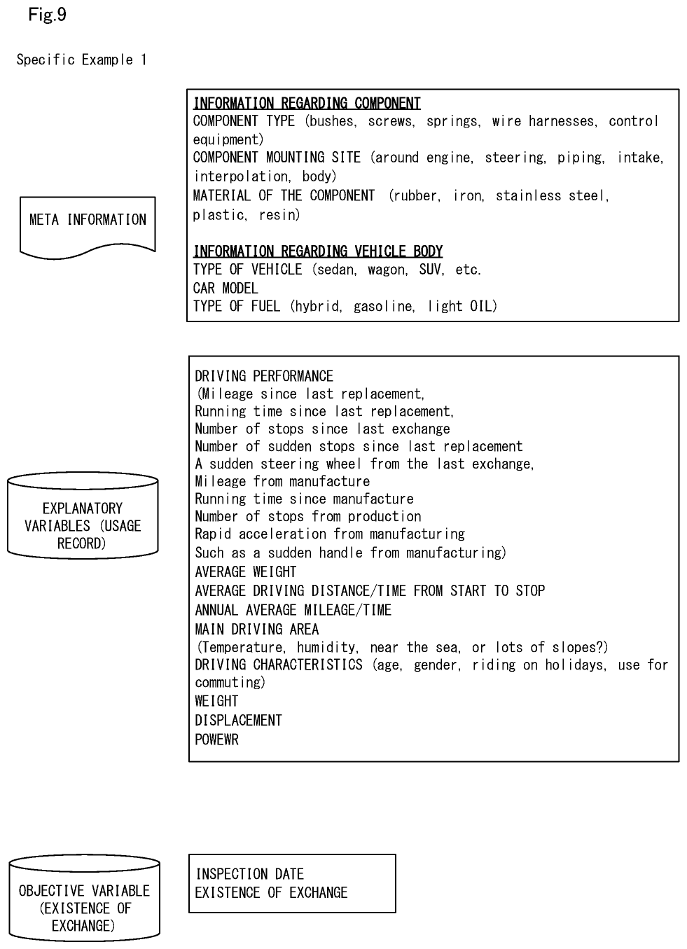

Next, specific examples of the first and second example embodiments will be described with reference to FIGS. 9 to 11. FIGS. 9 to 11 show information to be used for the specific examples.

### Specific Example 1

Specific Example 1 is an example in which the demand estimation apparatus 10 or 110 estimates demand for a maintenance component owned by an automobile dealer. As shown in FIG. 9, in Specific Example 1, information regarding a component (the type, the mounting site, and the material of the component), information regarding a vehicle body in which the component is mounted (the type of vehicle and the type of fuel), and the like are used as meta-information. The use environment of the component such as travelling records, the average weight, the average travelling distance/time from start to stop, the climate in a region in which the vehicle has mainly travelled (temperature, humidity, amount of rain, the presence or absence of snowfall, etc.,) and the like are used as information regarding use of the component represented as explanatory variables. An inspection day, whether or not replacement is to be performed, and the like are used as information regarding demand for the component represented as objective variables.

The automobile dealer can specify meta-information and a use environment of even a new component. Thus, as illustrated in Specific Example 1, the demand estimation apparatus 10 or 110 estimates whether or not replacement of a maintenance component is to be performed at the time of a periodic inspection even if the maintenance component is a new component. According to Specific Example 1, the automobile dealer can optimize an inventory of maintenance components by estimating demand for a repair component. Furthermore, the automobile dealer can improve the client satisfaction and the operating efficiency of parking lot also, by shortening repair periods.

### Specific Example 2

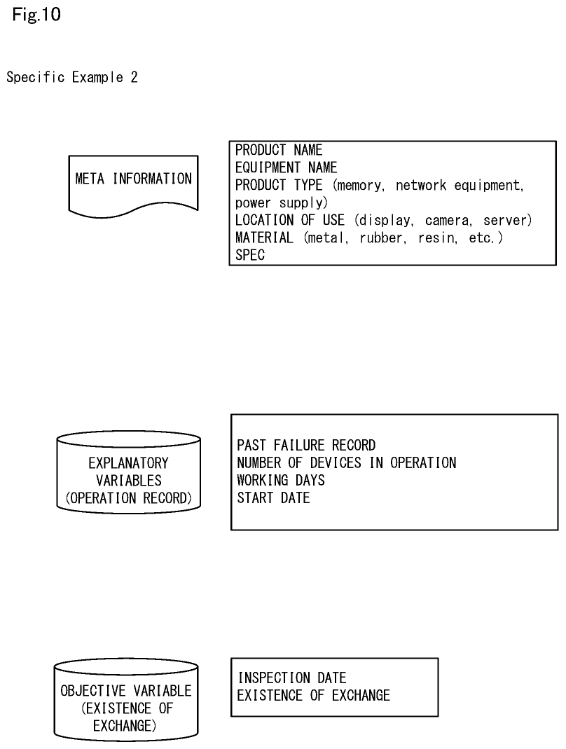

Specific Example 2 is an example in which the demand estimation apparatus 10 or 110 estimates demand for a maintenance component of a server apparatus. As shown in FIG. 10, in Specific Example 2, a product name, an apparatus name, a type of goods, and the like are used as meta-information. Operation records such as past failure records, the number of devices in operation, the number of days of operation, and the use start date of a server apparatus, and the environment in which the server apparatus was installed are used as information regarding use of the component represented as explanatory variables. An inspection day, whether or not replacement is to be performed, and the like are used as information regarding demand for the component represented as objective variables.

The administrator of the server apparatus can specify meta-information of even a new component. Thus, as illustrated in Specific Example 2, the demand estimation apparatus 10 or 110 estimates whether or not periodic replacement is performed, even for a new component. According to Specific Example 2, when the server apparatus has a failure, the administrator of the server apparatus can promptly address the failure.

### Specific Example 3

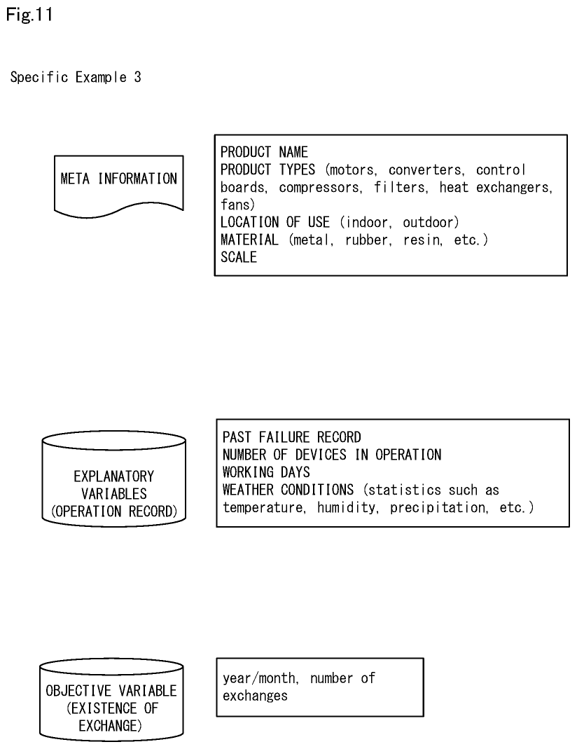

Specific Example 3 is an example in which the demand estimation apparatus 10 or 110 estimates a seasonally-varying demand for a maintenance component of a mechanical apparatus. As shown in FIG. 11, in Specific Example 3, a product name, a type of goods, a use site, a material, a scale, and the like are used as meta-information. Operation records such as past failure records, the number of devices in operation, the number of days of operation, and climate states are used as information regarding use of the component represented as explanatory variables. Month/year, the number of replacement components, and the like are used as information regarding demand for the component represented as objective variable.

The administrator of a mechanical apparatus can specify meta-information of even a new component. Thus, as illustrated in Specific Example 3, the demand estimation apparatus 10 or 110 estimates a replacement timing of even a new component. According to Specific Example 3, the administrator of the mechanical apparatus can estimate a replacement demand for a maintenance component of the mechanical apparatus for each season, and can promptly perform replacement of the maintenance component.

### Physical Configuration

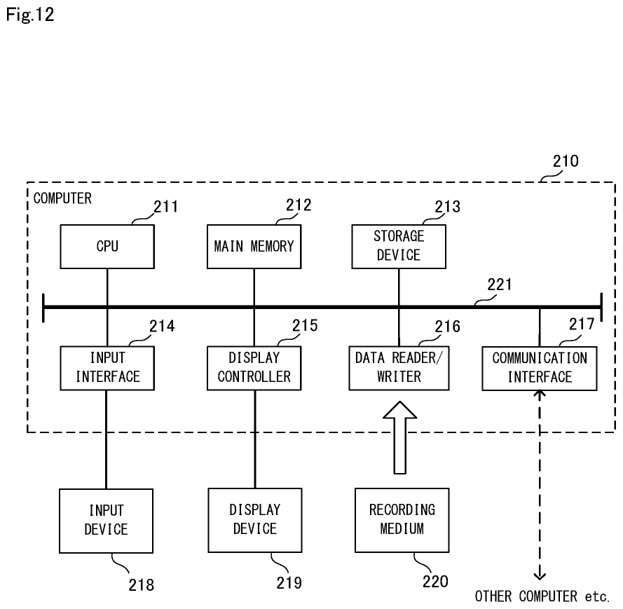

Using FIG. 12, the following describes a computer that realizes the information search apparatus by executing the program according to the first and second example embodiment. FIG. 12 is a block diagram illustrating an example of a computer that realizes the demand estimation apparatus according to the first and second example embodiment.

As shown in FIG. 12, a computer 210 includes a CPU (Central Processing Unit) 211, a main memory 212, a storage device 213, an input interface 214, a display controller 215, a data reader/writer 216, and a communication interface 217. These components are connected in such a manner that they can perform data communication with one another via a bus 221.

The computer 210 may include a GPU (Graphics Processing Unit) or an FPGA (Field-Programmable Gate Array) in addition to the CPU 211, or in place of the CPU 211. In this case, the GPU or the FPGA can execute the programs according to the example embodiment.

The CPU 211 deploys the program according to the example embodiment, which is composed of a code group stored in the storage device 213 to the main memory 212, and carries out various types of calculation by executing the codes in a predetermined order. The main memory 212 is typically a volatile storage device, such as a DRAM (dynamic random-access memory).

Also, the program according to the example embodiment is provided in a state where it is stored in a computer-readable recording medium 220. Note that the program according to the present example embodiment may be distributed over the Internet connected via the communication interface 217.

Also, specific examples of the storage device 213 include a hard disk drive and a semiconductor storage device, such as a flash memory. The input interface 214 mediates data transmission between the CPU 211 and an input device 218, such as a keyboard and a mouse. The display controller 215 is connected to a display device 219, and controls display on the display device 119.

The data reader/writer 216 mediates data transmission between the CPU 211 and the recording medium 220, reads out the program from the recording medium 220, and writes the result of processing in the computer 210 to the recording medium 220. The communication interface 217 mediates data transmission between the CPU 211 and another computer.

Specific examples of the recording medium 220 include: a general-purpose semiconductor storage device, such as CF (CompactFlash®) and SD (Secure Digital); a magnetic recording medium, such as a flexible disk; and an optical recording medium, such as a CD-ROM (Compact Disk Read Only Memory).

Note that the demand estimation apparatus according to the example embodiment can also be realized by using items of hardware that respectively correspond to the components, rather than the computer in which the program is installed. Furthermore, a part of the demand estimation apparatus may be realized by the program, and the remaining part of the demand estimation apparatus may be realized by hardware.

A part or an entirety of the above-described example embodiment can be represented by (Supplementary Note 1) to (Supplementary Note 15) described below, but is not limited to the description below.

### Supplementary Note 1

A demand estimation apparatus including:

a demand estimation unit that estimate demand for a new component by inputting meta-information of the new component and information regarding use of the new component to a machine learning model for receiving, as input, meta-information of an existent component and information regarding use of the existent component and estimating demand for the existent component.

### Supplementary Note 2

The demand estimation apparatus according to Supplementary Note 1,

wherein the meta-information of the new component includes at least one of a name, a type, a mounting site, and a material of the new component, and a name of an apparatus in which the new component is to be mounted,

the information regarding use of the new component includes at least one of information indicating a use record, information indicating an operation status, and information indicating a use environment, regarding the new component,

the meta-information of the existent component includes at least one of a name, a type, a mounting site, and a material of the existent component, and a name of an apparatus in which the existent component is to be mounted, and

the information regarding use of the existent component includes at least one of information indicating a use record, information indicating an operation status, and information indicating a use environment, regarding the existent component.

### Supplementary Note 3

A demand estimation apparatus including:

an estimation value obtaining unit that obtains an estimation value for a new component by inputting meta-information of the new component to a machine learning model for estimating demand for an existent component, the machine learning model receiving meta-information of an existent component as input and outputting an estimation value for demand for the existent component;

a model training unit that constructs a machine learning model for estimating demand for the new component by performing machine learning on a relation between the meta-information of the existent component, the obtained estimation value for the new component, and the meta-information of the new component; and

a demand estimation unit that estimates demand for the new component by inputting the meta-information of the new component to the machine learning model for estimating demand for the new component.

### Supplementary Note 4

The demand estimation apparatus according to Supplementary Note 3,

wherein the meta-information of the new component includes at least one of a name, a type, a mounting site, and a material of the new component, and a name of an apparatus in which the new component is to be mounted, and

the meta-information of the existent component includes at least one of a name, a type, a mounting site, and a material of the existent component, and a name of an apparatus in which the existent component is to be mounted.

### Supplementary Note 5

The demand estimation apparatus according to Supplementary Note 3 or 4,

wherein the model training unit constructs a machine learning model for estimating demand for the new component by executing weighting on the meta-information of the existent component and the meta-information of the new component using the obtained estimation value for the new component, the meta-information of the existent component, and the meta-information of the new component.

### Supplementary Note 6

A demand estimation method including:

a demand estimation step of estimating demand for a new component by inputting meta-information of the new component and information regarding use of the new component to a machine learning model for receiving, as input, meta-information of an existent component and information regarding use of the existent component and estimating demand for the existent component.

### Supplementary Note 7

The demand estimation method according to Supplementary Note 6,

wherein the meta-information of the new component includes at least one of a name, a type, a mounting site, and a material of the new component, and a name of an apparatus in which the new component is to be mounted,

the information regarding use of the new component includes at least one of information indicating a use record, information indicating an operation status, and information indicating a use environment, regarding the new component,

the meta-information of the existent component includes at least one of a name, a type, a mounting site, and a material of the existent component, and a name of an apparatus in which the existent component is to be mounted, and

the information regarding use of the existent component includes at least one of information indicating a use record, information indicating an operation status, and information indicating a use environment, regarding the existent component.

### Supplementary Note 8

A demand estimation method including:

an estimation value obtaining step of obtaining an estimation value for a new component by inputting meta-information of the new component to a machine learning model for estimating demand for an existent component, the machine learning model receiving meta-information of an existent component as input and outputting an estimation value for demand for the existent component;

a model training step of constructing a machine learning model for estimating demand for the new component by performing machine learning on a relation between the meta-information of the existent component, the obtained estimation value for the new component, and the meta-information of the new component; and

a demand estimation step of estimating demand for the new component by inputting the meta-information of the new component to the machine learning model for estimating demand for the new component.

### Supplementary Note 9

The demand estimation method according to Supplementary Note 8,

wherein the meta-information of the new component includes at least one of a name, a type, a mounting site, and a material of the new component, and a name of an apparatus in which the new component is to be mounted, and

the meta-information of the existent component includes at least one of a name, a type, a mounting site, and a material of the existent component, and a name of an apparatus in which the existent component is to be mounted.

### Supplementary Note 10

The demand estimation method according to Supplementary Note 8 or 9,

wherein, in the model training step, a machine learning model for estimating demand for the new component is constructed by executing weighting on the meta-information of the existent component and the meta-information of the new component using the obtained estimation value for the new component, the meta-information of the existent component, and the meta-information of the new component.

### Supplementary Note 11

A computer-readable recording medium that includes a program recorded thereon, the program including instructions that cause a computer to carry out:

a demand estimation step of estimating demand for a new component by inputting meta-information of the new component and information regarding use of the new component to a machine learning model for receiving, as input, meta-information of an existent component and information regarding use of the existent component and estimating demand for the existent component.

### Supplementary Note 12

The computer-readable recording medium according to Supplementary Note 11,

wherein the meta-information of the new component includes at least one of a name, a type, a mounting site, and a material of the new component, and a name of an apparatus in which the new component is to be mounted,

the information regarding use of the new component includes at least one of information indicating a use record, information indicating an operation status, and information indicating a use environment, regarding the new component,

the meta-information of the existent component includes at least one of a name, a type, a mounting site, and a material of the existent component, and a name of an apparatus in which the existent component is to be mounted, and

the information regarding use of the existent component includes at least one of information indicating a use record, information indicating an operation status, and information indicating a use environment, regarding the existent component.

### Supplementary Note 13

A computer-readable recording medium that includes a program recorded thereon, the program including instructions that cause a computer to carry out:

an estimation value obtaining step of obtaining an estimation value for a new component by inputting meta-information of the new component to a machine learning model for estimating demand for an existent component, the machine learning model receiving meta-information of an existent component as input and outputting an estimation value for demand for the existent component;

a model training step of constructing a machine learning model for estimating demand for the new component by performing machine learning on a relation between the meta-information of the existent component, the obtained estimation value for the new component, and the meta-information of the new component; and

a demand estimation step of estimating demand for the new component by inputting the meta-information of the new component to the machine learning model for estimating demand for the new component.

### Supplementary Note 14

The computer-readable recording medium according to Supplementary Note 13,

wherein the meta-information of the new component includes at least one of a name, a type, a mounting site, and a material of the new component, and a name of an apparatus in which the new component is to be mounted, and

the meta-information of the existent component includes at least one of a name, a type, a mounting site, and a material of the existent component, and a name of an apparatus in which the existent component is to be mounted.

### Supplementary Note 15

The computer-readable recording medium according to Supplementary Note 13 or 14,

wherein, in the model training step, a machine learning model for estimating demand for the new component is constructed by executing weighting on the meta-information of the existent component and the meta-information of the new component using the obtained estimation value for the new component, the meta-information of the existent component, and the meta-information of the new component.

Although the invention of the present application has been described above with reference to the example embodiment, the invention of the present application is not limited to the above-described example embodiment. Various changes that can be understood by a person skilled in the art within the scope of the invention of the present application can be made to the configuration and the details of the invention of the present application.

### INDUSTRIAL APPLICABILITY

As described above, according to the present invention, it is possible to estimate demand for even a component with few records of past shipment. The present invention is useful for equipment requiring maintenance such as automobiles, machines, railways, and computers.

### REFERENCE SIGNS LIST

10 Demand estimation apparatus (first example embodiment)

20 Demand estimation unit

30 Data obtaining unit

40 Model training unit

50 Model storage unit

60 Output unit

110 Demand estimation apparatus (second example embodiment)

120 Demand estimation unit

130 Data obtaining unit

140 Model training unit

150 Model storage unit

160 Output unit

170 Estimation value obtaining unit

210 Computer

211 CPU

212 Main memory

213 Storage device

214 Input interface

215 Display controller

216 Data reader/writer

217 Communication interface

218 Input device

219 Display device

220 Recording medium

221 Bus

What is claimed is:

1. A demand estimation apparatus comprising
at least one memory storing instructions; and
at least one processor configured to execute the instructions to:
estimate demand for a new component by inputting meta-information of the new component and information regarding use of the new component to a machine learning model for receiving, as input, meta-information of an existent component and information regarding use of the existent component and estimating demand for the existent component.

2. The demand estimation apparatus according to claim 1,
wherein the meta-information of the new component includes at least one of a name, a type, a mounting site, and a material of the new component, and a name of an apparatus in which the new component is to be mounted,
the information regarding use of the new component includes at least one of information indicating a use record, information indicating an operation status, and information indicating a use environment, regarding the new component,
the meta-information of the existent component includes at least one of a name, a type, a mounting site, and a material of the existent component, and a name of an apparatus in which the existent component is to be mounted, and
the information regarding use of the existent component includes at least one of information indicating a use record, information indicating an operation status, and information indicating a use environment, regarding the existent component.

3. (canceled)

4. (canceled)

5. (canceled)

6. A demand estimation method comprising:
estimating demand for a new component by inputting meta-information of the new component and information regarding use of the new component to a machine learning model for receiving, as input, meta-information of an existent component and information regarding use of the existent component and estimating demand for the existent component.

7. The demand estimation method according to claim 6,
wherein the meta-information of the new component includes at least one of a name, a type, a mounting site, and a material of the new component, and a name of an apparatus in which the new component is to be mounted,
the information regarding use of the new component includes at least one of information indicating a use record, information indicating an operation status, and information indicating a use environment, regarding the new component,
the meta-information of the existent component includes at least one of a name, a type, a mounting site, and a material of the existent component, and a name of an apparatus in which the existent component is to be mounted, and
the information regarding use of the existent component includes at least one of information indicating a use record, information indicating an operation status, and information indicating a use environment, regarding the existent component.

8. (canceled)

9. (canceled)

10. (canceled)

11. A non-transitory computer-readable recording medium that includes a program recorded thereon, the program including instructions that cause a computer to:
estimate demand for a new component by inputting meta-information of the new component and information regarding use of the new component to a machine learning model for receiving, as input, meta-information of an existent component and information regarding use of the existent component and estimating demand for the existent component.

12. The non-transitory computer-readable recording medium according to claim 11,
wherein the meta-information of the new component includes at least one of a name, a type, a mounting site, and a material of the new component, and a name of an apparatus in which the new component is to be mounted,
the information regarding use of the new component includes at least one of information indicating a use record, information indicating an operation status, and information indicating a use environment, regarding the new component,
the meta-information of the existent component includes at least one of a name, a type, a mounting site, and a material of the existent component, and a name of an apparatus in which the existent component is to be mounted, and
the information regarding use of the existent component includes at least one of information indicating a use record, information indicating an operation status, and information indicating a use environment, regarding the existent component.

13. (canceled)

14. (canceled)

15. (canceled)
